(19) United States
(12) Patent Application Publication
(10) Pub. No.: US 2021/0142346 A1
(43) Pub. Date: May 13, 2021

(54) SYNTHESIS OF PURCHASING DATA FROM SHOPPER LOYALTY CARDS AND CONSUMER PANELS

(71) Applicant: Information Resources, Inc., Chicago, IL (US)

(72) Inventors: Drew Edward Swartz, Highland Park, IL (US); Abhishek Ashok Parab, Chicago, IL (US)

(21) Appl. No.: 17/096,572

(22) Filed: Nov. 12, 2020

Related U.S. Application Data
(60) Provisional application No. 62/934,172, filed on Nov. 12, 2019.

(51) Int. Cl. G06Q 30/02; G06Q 20/20; G06N 20/00

(52) U.S. Cl. CPC G06Q 30/0205; G06Q 30/0201; G06N 20/00; G06Q 30/0226; G06Q 30/0238; G06Q 20/202

(57) ABSTRACT

Purchasing data from a variety of sources such as consumer panels, loyalty cards, and retailer point of sale data, are fused to estimate purchasing behavior by loyalty card users. As a significant advantage, the techniques described herein permit accurate imputation, on a household level, of unreported purchases in loyalty card data, and can thus facilitate accurate estimates of total spending behavior by loyalty card households beyond those venues for which loyalty program data is collected.

### CROSS-REFERENCE TO RELATED APPLICATIONS

This application claims priority to U.S. Provisional Patent Application No. 62/934,172 filed on Nov. 12, 2019, the entire content of which is hereby incorporated herein by reference.

### TECHNICAL FIELD

The present disclosure generally relates to the synthesis of purchasing data from shopper loyalty and consumer panels, e.g., for estimating household spending.

### BACKGROUND

Data that characterizes purchasing behavior of consumers is stored at a variety of locations and in a variety of forms. For example, this may include national demographic data, point of sale data for a retail concern, and/or loyalty card data. Each source of data provides different information, and is susceptible to different biases, misreporting, and so forth. A variety of techniques have been devised for adapting these various sources of data to support business decisions. For example, U.S. Pat. No. 8,589,208, which is incorporated by reference herein in its entirety, describes techniques for combining uncorrelated data sources such as consumer panels and point of sale data to support inferences about purchasing behavior.

There remains a need for improved techniques to estimate household purchasing and other consumer activity.

### SUMMARY

Purchasing data from a variety of sources such as consumer panels, loyalty cards, and retailer point of sale data, are fused to estimate purchasing behavior by loyalty card users. As a significant advantage, the techniques described herein permit accurate imputation, on a household level, of unreported purchases in loyalty card data, and can thus facilitate accurate estimates of total spending behavior by loyalty card households beyond those venues for which loyalty program data is collected.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a system for estimating household spending.

FIG. 2 is a flow chart of a method for estimating household spending.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, for example, the term “or” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” and the like, are words of convenience and are not to be construed as limiting terms.

Described herein are devices, systems, computer program products, and methods for modeling and estimating household spending on consumer products. In this manner, the present disclosure includes techniques for processing purchasing data from a variety of sources to estimate household-level purchasing activity and the like. Specifically, a technique according to the present disclosure may include the use of point of sale data, consumer panel data, and loyalty card data, where each may be derived from a different source, and where each may have different attributes and coverage. Advantageously, the purchasing data (e.g., the shopper loyalty data) may be demographically weighted to make it representative of a national population. In this manner, total spend for a household can be estimated at a product-by-product level, and the household spend on each product may be estimated for each outlet. Thus, the present teachings may include a demographic weighting technique, a total spend estimation technique, and a share allocation technique, as well as validation for any and all of the above.

It will be understood that the present teachings may be implemented using, e.g., any of the platforms, methods, or computer code described in the disclosure of U.S. Pat. No. 8,589,208, which is incorporated by reference herein, including by way of non-limiting example any of the data integration systems, data sources, computing hardware and software, programs, engines, communications infrastructures, and so forth disclosed therein.

FIG. 1 shows a system for estimating household spending. In general, the system 100 may be used to provide, as output 148, a single-source data set that combines the scale and accuracy of retailer loyalty card data with household granularity of consumer panel data. In general, there are a variety of commercially available data sources providing information on consumer activity. For example, retailer's point of sale data provides highly accurate information on total sales of products by a retailer over time. However, this point of sale data is not correlated to individual shoppers, or to baskets of goods that are purchased together at a single time. In part to fill this gap, consumer panels have been created that recruit volunteers who self-report all shopping activity, including all purchases across all retail outlets. This second data source can, however, introduce errors due to misreporting of actual activity, e.g., where certain shopping trips are omitted, or where specific items are omitted or attributed to the wrong retail outlet. Additionally, these consumer panels tend to be small when compared to an overall population, thus presenting statistical barriers to highly granular insights, particularly for low-volume purchases. Finally, shopper loyalty data, which captures some/all purchases by loyalty card holders at particular retail outlets, can provide accurate data on baskets of goods purchased by participating households. However, even this data has limitations, perhaps most significantly that the loyalty card data only reflects a subset of each household's total spend on consumer goods, and it may be difficult to determine what percentage of total shopping activity is covered by loyalty card data for a household. As a significant advantage, the techniques described herein overcome these deficiencies using a data-driven underreporting model to ensure that overlaps and gaps in reporting between these various data sets are accurately reconciled based on available information about individual consumer behavior, yielding a model for estimating household spend, e.g., on consumer goods, that substantially improves on the existing techniques. These improved models may usefully be employed to estimate future shopping activity with greater accuracy, scale, and granularity than other models of the prior art.

The system 100 may include a networked environment where a data network 102 interconnects a plurality of participating devices and/or users in a communicating relationship. However, it will be understood that one or more of the participants in the system 100 may be connected without the use of a data network 102. The system 100 may generally include one or more sources of data (e.g., a first source 110, a second source 120, and a third source 130 as shown in the figure), a data processing engine 140 or platform, a database 150, and one or more other computing resources 160.

The data network 102 may be any network(s) or internetwork(s) suitable for communicating data and information among participants in the system 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m)), fifth generation (e.g., 5G), and/or other technologies, as well as any of a variety of corporate area or local area networks and other switches, routers, hubs, gateways, and the like that might be used to carry data among participants in the system 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications. The network interface may include without limitation a wired Ethernet network interface card (“NIC”), a wireless 802.11 networking card, a wireless 802.11 USB device, or other hardware for wired or wireless local area networking. The network interface may also or instead include cellular network hardware, wide area wireless network hardware or any other hardware for centralized, ad hoc, peer-to-peer, or other electrical, radio, acoustic, or optical communications that might be used to connect to a network and carry data. In another aspect, the network interface may include a serial or USB port to directly connect to a local computing device such as a desktop computer that, in turn, provides more general network connectivity to the data network 102.

The first source 110 of data may include a retailer that provides point of sale data 112 related to a first plurality of consumers 114. While a single source is illustrated, it will be understood that this may include point of sale data 112 from different retail locations operated by one or more different retailers. Thus, the point of sale data 112 may include sale data on a location-by-location basis, a company-by-company basis, or some combination of these. Also or instead, the point of sale data 112 may be aggregated, summarized, obfuscated, or otherwise processed for third-party use. The point of sale data 112 may include granular information, such as data related to any checkout at a retail store, handheld point of sale hardware, scanners from mobile applications (barcode scanners, QR code scanners, and the like), and so on. The point of sale data 112 may also or instead include data on a macro scale that is collected from groups of retailers and aggregated by an intermediate entity. Thus, the point of sale data 112 can provide a relatively accurate measurement of total market sales and trends by any/all participating retailers, but may lack the information needed to break out sales by consumer or basket.

The second source 120 of data may be a marketing company that acquires and provides consumer panel data 122 related to a second plurality of consumers 124. The consumer panel data 122 may include self-reported purchases for a group of consumers or the like, or any other data gathered for a group of volunteers or similar panel participants. The consumer panel data 122 may help with insights into consumer behavior and shifting trends and may contain information relating to shopping patterns among different retailers, purchasing behaviors, consumer demographic information, and so forth. The consumer panel data 122 may thus yield insights into the impact of marketing initiatives on consumers' attitudes, behavior, and purchases. However, the consumer panel data 122 may include sample sizes that are too small relative to a general population, and that accordingly limit the granularity of insights derived therefrom.

The third source 130 of data may include loyalty card programs for retailers. In general, loyalty card participants may generate loyalty card data 132 related to a third plurality of consumers 134, e.g., for a particular retailer. The loyalty card data 132 generally includes data that records loyalty card purchases of one or more products by members of the third plurality of consumers 134 at one or more outlets operated by a retailer. Thus, it will be understood that the loyalty card data 132 may include information related to consumer behavior when using a loyalty card or the like—e.g., a membership card (which can be a physical card, a digital card, or a combination thereof), a re-usable discount code, a subscription, a customer number or identifier, a credit card or debit card related to a retailer, a gift card, a coupon, and so on. Loyalty card data 132 can help retailers understand consumer behavior by providing very specific purchase basket information for specific individuals or households. However, while loyalty card data 132 supports granular analyses across product, time, and consumer dimensions, loyalty card data 132 generally only reflects a subset of each households' total spend.

One or more of the first source 110, second source 120, and third source 130 of data may be aggregated by an analytics provider and stored within a single data store in certain implementations—e.g., where this data is collected by a single entity and stored in a database 150 or the like. In general, the technical challenges to integrating these sources of information do not lie in the area of aggregating data from different sources. Rather, the challenges arise because the relationship between purchases from each source are largely unknown. That is, each individual consumer transaction reflected in one of the data sets 112, 122, 132 may or may not be reflected in other ones of the data sets 112, 122, 132. For example, a loyalty card user may purchase goods in a transaction that is recorded in the loyalty card data 132, however, it may not be known whether this loyalty card user is also a consumer panel member that records transactions in the consumer panel data 122. Similarly, although a retailer may know precisely how much of a product is purchased at each store and across all stores over a given time period, the retailer may not be able to determine the composition of purchases of that product, and/or whether a particular consumer also purchased that product over a given time period at other retailers. Thus in general, it is generally unknown whether one of the first plurality of consumers 114 overlaps with the second plurality of consumers 124 and/or the third plurality of consumers 134, and to the extent that an overlap might be inferred, the degree of such overlap will generally be unknown.

As described herein, to address this difficulty, the point of sale data 112, the consumer data 122, and the loyalty card data 132 may be processed in the system 100 (along with general demographic information for a population), e.g., by a data processing engine 140, to create a comprehensive data set that reflects useful characteristics of each constituent data set. The data processing engine 140 may have access to the data from one or more of the first source 110, the second source 120, and the third source 130, e.g., over the data network 102, for processing thereof. To this end, the data processing engine 140 may include, or otherwise be in communication with, a processor 142 and a memory 144, where the memory 144 stores code executable by the processor 142 to perform various techniques of the present teachings. Further, the data processing engine 140 (or a component thereof such as the memory 144 or another participant in the system 100 ) may store and/or employ one or more models 146 (e.g., machine learning models or algorithms implemented by such models) for processing data. The memory 144 may also or instead contain any of the processed or unprocessed data as described herein.

In certain aspects, the memory 144 stores code executable by the processor 142 to acquire data for processing—e.g., the point of sale data 112, the consumer panel data 122, and the loyalty card data 132. The memory 144 may also or instead store code executable by the processor 142 to demographically weight the loyalty card data 132 to represent a national market by weighting each of a number of purchasing segments as a ratio of national households in that purchasing segment to loyalty card households in that purchasing segment. Further, the memory 144 may store code executable by the processor 142 to estimate a first household spend by the third plurality of consumers 134 for a number of products on a per-product basis using a probabilistic distribution to adjust for underreporting of product purchases within the loyalty card purchases by the third plurality of consumers 134 based on distributions of the loyalty card data 132, the consumer panel data 122, and the point of sale data 112. The memory 144 may also or instead store code executable by the processor 142 to train a model 146 (e.g., a machine learning model) with the consumer panel data 122 to estimate a proportion of shopping trips made by a group of consumers to a second plurality of outlets not included in the first plurality of outlets, and to estimate a second household spend by the third plurality of consumers 134 on one of the number of products on a per outlet basis by applying the model 146 to identify unreported purchases of the product in the loyalty card data 132 by the third plurality of consumers 134. More generally, the memory 144 may store compute executable code that configures the processor 142 to perform any of the steps in the methods herein.

Output 148 of the data processing engine 140 may include any of the aforementioned information such as an estimate of unreported purchases, estimated household spends, estimated number of shopping trips, estimated basket composition, weighted loyalty card data, and so on. The output 148 may be configured for human interaction, e.g., within a user interface of a computing device or the like. The output 148 may also or instead include a report, a spreadsheet, a document, a chart, a graph or graphic, a computer file, and the like.

The data processing engine 140 may also or instead include data storage, a network interface, and/or other processing circuitry. In the following description, where the functions or configuration of a data processing engine 140 are described, this is intended to include corresponding functions or configuration (e.g., by programming) of a processor 142 of the data processing engine 140, or in communication with the data processing engine 140. In general, the data processing engine 140 (or processors 142 thereof or in communication therewith) may perform a variety of processing tasks related to the secure processing of data as discussed herein. For example, the data processing engine 140 may manage information received from one or more of the data sources, and provide related supporting functions such as generating, receiving, and/or transmitting data, communicating with other resources 160, storing data, and the like. The data processing engine 140 may also or instead include backend algorithms that react to actions performed by a user of the system 100. The backend algorithms may also or instead be located elsewhere in the system 100.

The data processing engine 140 may also or instead include a web server or similar front end that facilitates web-based access via the network 102 to the capabilities of the data processing engine 140 or other components of the system 100. The data processing engine 140 may also or instead communicate with other resources 160 in order to obtain information, e.g., in response to user inquiries or in order to process data as described herein. For example, where broad demographic data is desired, national data from any commercially available data provider may be accessed. Additional processing may be usefully performed by the data processing engine 140 such as recommending certain data processing operations, data sources, filters, and so forth.

In another aspect, the data processing engine 140 may maintain, or otherwise be in communication with, a database 150 of content distinct from the other sources of data described herein. For example, the database 150 may store models 146 for use in data processing, output 148 of the data processing engine 140, and so forth. The database 150 may also or instead include pre- or post-processed data from the other sources of data described herein—e.g., the first source 110, the second source 120, and the third source 130.

In the system 100, one or more of the other computing resources 160 may include any resources that may be usefully employed in the devices, systems, and methods as described herein. For example, the other resources 160 may include without limitation other data networks, human actors, sensors (e.g., audio or visual sensors), data mining tools, computational tools, data monitoring tools, data sources, and so forth. The other resources 160 may also or instead include any other software or hardware resources that may be usefully employed in the networked applications as contemplated herein. For example, the other resources 160 may include payment processing servers or platforms used to authorize payment for access, content or feature purchases, access to external resources requiring payment, and so forth. In another aspect, the other resources 160 may include certificate servers or other security resources for third-party identity management, encryption or decryption of data, authentication, and so forth. In another aspect, the other resources 160 may include a desktop computer or the like co-located (e.g., on the same local area network with, or directly coupled to through a serial or USB cable) with another participant in the system 100. In this case, the other resource 160 may provide supplemental functions for another participant in the system 100. Other resources 160 may also or instead include supplemental resources such as scanners, cameras, printers, input devices, and so forth.

While depicted as a separate network entity, it will be readily appreciated that the other resources 160 (e.g., a web server) may also or instead be logically and/or physically associated with one of the other devices described herein, and may, for example, include or provide a user interface for web access to the data processing engine 140 or the database 150 in a manner that permits user interaction through the data network 102.

FIG. 2 is a flow chart of a method for estimating household spending. The method 200 may be implemented using the system 100 described above, or similar.

As shown in step 202, the method 200 may include acquiring point of sale data for a first plurality of consumers. This may, for example, include point of sale data from retail locations operated by one or more retailers, including, e.g., per-store and per-product sales volumes on a periodic basis, e.g., daily, weekly, monthly, quarterly, or annually. In general, stores may be categorized using any suitable attributes such as size and geographic market. Products may be organized by any information associated with individual point-of-sale stockkeeping units (or other labels or identifiers including) including without limitation product name, product type, brand, size, packaging, and so forth. A retailer's point of sale data can provide a highly accurate measurement of market sales for that retailer in a manner that is generally uncorrelated to particular consumers or households. However, it will be understood that, while a particular retailer may track point of sale data on a location-by-location basis, the data may also or instead be aggregated or otherwise processed for third-party use.

As shown in step 204, the method 200 may include acquiring consumer panel data from a second plurality of consumers. In general, to acquire consumer panel data, individual consumers scan or otherwise record baskets of purchases, e.g., with a handheld scanner at home (or in a store or other location), or with a mobile phone application at any convenient time, and provide supplemental information such as the retailer(s) where the purchases were made. Consumer panels generally provide self-reported information about shopping behavior by particular consumers or households. While this provides useful household-level data, the data is generally obtained from a more limited population of recruited participants and may also be subject to underreporting of purchases or other reporting mistakes or omissions by panel members. In general, the relationship between the consumers represented in the point of sale data and the consumers represented in the consumer panel will be unknown, and one group of consumers may be entirely within, entirely without, or partially overlapping with the other group of consumers.

As shown in step 206, the method 200 may include acquiring loyalty card data from a third plurality of consumers. The loyalty card data may generally include data acquired based on loyalty card purchases or other purchases from known consumers, such as member purchases, discount-program participants, and the like. This may include purchases of one or more products by the third plurality of consumers at a first plurality of outlets operated by a retailer. This data may provide highly accurate and granular information about purchase baskets for individual consumers or households. However, this data can also be subject to underreporting, for example, where consumers forget to use their loyalty cards or, perhaps more significantly, where consumers engage in related purchasing activity (e.g., for similar or identical goods) at other retail outlets.

In general, the overlap between the first plurality of consumers, the second plurality of consumers, and the third plurality of consumers may be unknown and/or it may vary over time. That is, while the overlap among any two of these groups can often be measured or estimated using a variety of techniques, the composition of each group of consumers may change over time, and as such, the overlap may change or vary over time, generally making a prospective overlap difficult to predict or accurately model.

As shown in step 208, the method 200 may include demographically weighting the loyalty card data to represent a national market. Demographically weighting the loyalty card data may include weighting each of a number of purchasing segments as a ratio of national households in that purchasing segment to loyalty card households in that purchasing segment. For example, one technique for weighting includes use of the following formula:

$$Weight of Segment S = \frac{\# ( Total Household ⋂ S )}{\# ( Shopper Loyalty Household ⋂ S )}$$

Although not shown, national household data may be obtained for this purpose from any of a variety of commercial data providers and may include national and/or regional compositions of a population according to any number of demographic criterial. This demographically weighted loyalty card data may be used as the loyalty card data for subsequent processing described herein.

As shown in step 210, the method 200 may include estimating a first household spend, more specifically, the total household spend, by the third plurality of consumers for a number of products on a per-product basis. While a number of naive assumptions may be applied to estimate the total household spend, the techniques described herein may advantageously employ a statistically accurate, data-driven model of underreporting to more accurately extrapolate total consumer spend, at the household level, based on loyalty card spend. This may be accomplished, for example, using a probabilistic distribution to adjust for underreporting of product purchases within the loyalty card purchases by the third plurality of consumers based on distributions of the loyalty card data, the consumer panel data, and the point of sale data. Stated otherwise, the probabilistic distribution may be used to fit existing data and/or model the underreporting of transactions.

A probabilistic distribution to adjust for underreporting of product purchases may include one or more of a beta binomial/negative binomial distribution and a beta binomial/negative binomial hurdle distribution. For example, a beta binomial/negative binomial distribution has been demonstrated to be useful in modeling non-reporting or underreporting of events such as consumer purchases. A beta binomial/negative binomial hurdle distribution is also useful in this context, and has been demonstrated to more accurately model underreporting of events under certain conditions. By way of example, use of the beta binomial/negative binomial hurdle distribution permits estimation of the distribution of the total spend including unreported purchases in the loyalty card data. Suitable techniques for imputing actual events based on a set of known events is described for example in Goerg, et al., “How Many Millennials visit YouTube? Estimating Unobserved Events From Incomplete Panel Data Conditioned on Demographic Covariates,” Google Inc. (Apr. 27, 2015), which is incorporated herein by reference in its entirety. While Goerg, et al. specifically addresses imputing web advertising impressions based on a statistical comparison of advertisements viewed by a reporting panel to advertisements served through a website, the techniques are equally applicable here, where data is provided for both total purchasing activity over some domain (loyalty card data) and specific purchasing activity by a known consumer panel.

Significantly, this approach permits accurate household-level inferences to be derived from a panel of reporting households. That is, modeling of consumer purchasing activity can reach the household level for all purchasing activity, not just consumer panel activity or loyalty card data, based on an accurate model of underreporting within the available data sets. These or other similar probabilistic distributions or models may be used to estimate underreporting (or more generally, misreporting) of product purchases within the loyalty card purchases by the third plurality of consumers. Using these types of models, the loyalty card purchasing activity may be adjusted based on other information to estimate total purchasing (not just loyalty card purchasing) by loyalty card users.

As shown in step 212, the method 200 may include training a machine learning model with the consumer panel data. And, as shown in step 214, the trained model may be used to estimate shopping behavior. More specifically, the method 200 may include using the trained model to estimate a proportion of shopping trips made by a group of consumers to a second plurality of outlets not included in the first plurality of outlets.

The consumer panel data may be advantageously employed for training the machine learning model because, in general, the consumer panel data provides complete, or nearly complete, information about shopping behavior at the household level. Thus, consumer panel data may characterize shopping activity that is not, and generally cannot be, captured by a loyalty card for a particular retailer, or even for a group of retailers. In this manner, using consumer panel data or similar data, the machine learning model may be trained to estimate what proportion and type of purchases a consumer makes at what retail outlets independent of loyalty card usage based on behavior of a consumer panel.

In general, the machine learning model may use predictors based on attributes that are shared between panel data and loyalty card data, while using outlets as dependent variables. The predictors may, for example, include demographics such as income, family composition, geographic category, distance from retailers, and the like. By way of example, for geographic distance, the physical location (e.g., GPS location, physical coordinates, or trade area) for households and various retailers may be known. This information can facilitate direct calculation of a linear distance (or another route distance) between a household and surrounding retailers. It will be understood that a consumer panel may report the banner (e.g., the name of a store) for a purchase, but may not identify a particular store at which a purchase was made. In order to correlate this information to local purchasing behavior, the store or outlet may be selected using a nearest location for a banner, e.g., based on a literal geographic distance from the panel member household. In another aspect, a trade area for the household may be used instead of, or in addition to, physical distance to measure where a shopper is most likely to visit.

In one aspect, one of the dependent variables may pertain to purchases or spend at retail outlets. The term ‘outlet’ as used herein generally refers to a type of retail outlet, such as drug stores, club stores, grocery stores, convenience stores, and so forth. A few retailers are sufficiently large that they may be counted as a separate outlet type. For example, where a particular retailer accounts for a double digit percentage of sales, that retailer may be counted as a separate outlet for purposes of modeling as described herein. It will be also appreciated that the techniques described herein may also or instead be used to make predictions on a more granular level, such as the retail banner level (e.g., all stores belonging to a particular company or brand), or any other useful level, and that other dependent variables may also or instead be used without departing from the scope of this disclosure.

As shown in step 216, the method 200 may include applying the machine learning model to identify unreported purchases of a product in the loyalty card data by the third plurality of consumers. And, by applying the machine learning model to identify total spend by loyalty card (or loyalty program) users the method 200 may, as shown in step 218, include estimating a second household spend by the third plurality of consumers on one of the number of products on a per outlet basis, or on any other basis or aggregation level of interest. In general, as noted herein, the model may be trained to output specific underreporting information, or to output specific total spend information, or to output proportional spend information, or any combination of these.

In general, the machine learning model may be configured to receive loyalty card data, and to estimate a proportion of trips made to retailers or retail channels that are not included in the loyalty card data, thus providing an estimate of total spend information for loyalty card users. It will be understood that numerous alternative configurations of the machine learning model are possible including various coding trees, latent spaces, and decoding trees. For example, the model may be trained to receive loyalty card data, point of sale data, and/or panel data, and to generate outputs such as total spend for loyalty card users on a per-product basis, total unreported activity for consumer panel members on a per-household basis, and so forth, all generally based on accurate household-level imputation of unreported purchases as described herein.

Thus, the specific machine learning algorithm for producing estimates of unreported purchases may be constructed in variety of ways. For example, the machine learning model may estimate proportions of a whole, such as by representing the proportion of a single household's total purchases that are predicted to be made at a given retail outlet. Multiplying these proportions by the total spend estimate produced in step 210 can then produce an estimate of that household's shopping across each retail outlet. In another example, the machine learning model may directly estimate purchases or spend in various outlet venues in the same manner as a multivariate regression model or other model or technique. As yet another example, the machine learning model may be used to estimate one or more parameters of a statistical distribution such as the Dirichlet multinomial distribution or any other multinomial distribution or related distribution. Distributions from the multinomial family are popular in marketing, as they can be used to represent an individual's choice among competing alternatives, which in this case can represent the retail outlet at which a household chooses to shop. When combined with the total spend estimate from step 210, these statistical distributions can provide robust estimates of how a household's discrete purchase events are distributed over the various retail outlets or venues.

While multinomial distributions are useful, it will be appreciated that a number of other statistical distributions may also or instead be used to model consumer decisions or behavior, and may be adapted for use in place of the multinomial distributions as described herein. More generally, any suitable technique for estimating patterns of consumer choice or behavior may also or instead be used to model consumer behavior as contemplated herein, and may have one or more statistical parameters or other parameters evaluated using a suitably trained machine learning algorithm.

This information may usefully be applied in a number of ways to achieve practical results. For example, product manufacturers may use the estimates produced by this technique to measure the extent of consumer shopping in various retail outlets. This can lead to useful insights, for example, knowledge of the particular segments of households that favor one type of store over another (e.g., drug stores over grocery stores) when purchasing a particular product. Thus, a manufacturer can advantageously use this information to make supply chain and marketing decisions, such as whether to stock higher quantities of the product in a particular retail outlet, and/or whether to offer promotions to incentivize consumers to shop in a particular retail outlet. As another example, a retailer may use such estimates to identify specific products that are available in the retailer's store, but that customers are purchasing elsewhere. This information may in turn be used to offer promotions, adjust marketing strategy or advertising spend, or otherwise take steps to increase consumer awareness of products or increase consumer purchase of such products. In another aspect, a retailer may evaluate what percentage of product purchases its loyalty card purchasers are making in-store, or at competitor's stores. More generally, the techniques described herein may permit retailers, product manufacturers, and others to draw inferences from loyalty card data that describe consumers' shopping behavior outside of loyalty-card purchases, which can facilitate a wide range of analyses, as well as deployment of responsive manufacturing, marketing, and advertising resources or strategies.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The meanings of method steps of the invention(s) described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

Thus for example, a description or recitation of “adding a first number to a second number” includes causing one or more parties or entities to add the two numbers together. For example, if person X engages in an arm's length transaction with person Y to add the two numbers, and person Y indeed adds the two numbers, then both persons X and Y perform the step as recited: person Y by virtue of the fact that he actually added the numbers, and person X by virtue of the fact that he caused person Y to add the numbers. Furthermore, if person X is located within the United States and person Y is located outside the United States, then the method is performed in the United States by virtue of person X's participation in causing the step to be performed.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method, comprising:
acquiring point of sale data for a first plurality of consumers;
acquiring consumer panel data for a second plurality of consumers;
acquiring loyalty card data for a third plurality of consumers, the loyalty card data including loyalty card purchases of one or more products by the third plurality of consumers at a first plurality of outlets operated by a retailer, wherein an overlap between the first plurality of consumers, the second plurality of consumers, and the third plurality of consumers varies over time;
demographically weighting the loyalty card data to represent a national market by weighting each of a number of purchasing segments as a ratio of national households in that purchasing segment to loyalty card households in that purchasing segment;
estimating a first household spend by the third plurality of consumers for a number of products on a per-product basis using a probabilistic distribution to adjust for underreporting of product purchases within the loyalty card purchases by the third plurality of consumers based on distributions of the loyalty card data, the consumer panel data, and the point of sale data;
training a machine learning model with the consumer panel data to estimate a proportion of shopping trips made by a group of consumers to a second plurality of outlets not included in the first plurality of outlets; and
estimating a second household spend by the third plurality of consumers on one of the number of products on a per outlet basis by applying the machine learning model to identify unreported purchases of the one of the number of products in the loyalty card data by the third plurality of consumers.

2. The method of claim 1, wherein the probabilistic distribution includes a beta binomial/negative binomial distribution.

3. The method of claim 1, wherein the probabilistic distribution includes a beta binomial/negative binomial hurdle distribution.

4. The method of claim 1, wherein the machine learning model uses one or more predictors based on one or more items included in each of the consumer panel data and the loyalty card data, and wherein the machine learning model uses one or more outlets as a dependent variable.

5. The method of claim 4, wherein the one or more predictors include at least one of an income, a family composition, a geographic category, and a distance from retailers.

6. The method of claim 4, wherein the consumer panel data lacks identification of a particular outlet at which a particular purchase was made by a particular consumer, and wherein one or more of location data, geographic data, and a trade area for the particular consumer is used by the machine learning model to predict the particular outlet.

7. The method of claim 1, wherein the machine learning model uses a multivariate regression model.

8. The method of claim 1, wherein the machine learning model estimates one or more parameters of a statistical distribution.

9. The method of claim 8, wherein the statistical distribution includes a Dirichlet multinomial distribution.

10. The method of claim 1, wherein a dependent variable used by the machine learning model includes purchases at a retail outlet.

11. The method of claim 1, wherein the estimated second household spend is used as an input to measure an extent of consumer shopping in one or more retail outlets.

12. The method of claim 11, wherein the extent of consumer shopping provides data related to a type of retail outlet one or more consumers favor when purchasing a particular product.

13. The method of claim 1, wherein the estimated second household spend specifies a retail banner for one or more outlets where unreported purchases are estimated to be made.

14. The method of claim 1, wherein the consumer panel data includes additional shopping behavior for consumers relative to the loyalty card data.

15. The method of claim 1, wherein any overlap between the first plurality of consumers, the second plurality of consumers, and the third plurality of consumers is unknown.

16. The method of claim 1, wherein one or more of the first plurality of outlets and the second plurality of outlets includes at least one of a drug store, a club store, a grocery store, and a convenience store.

17. A computer program product comprising computer executable code embodied in a nontransitory computer readable medium that, when executing on one or more computing devices, performs the steps of:
acquiring point of sale data for a first plurality of consumers;
acquiring consumer panel data for a second plurality of consumers;
acquiring loyalty card data for a third plurality of consumers, the loyalty card data including loyalty card purchases of one or more products by the third plurality of consumers at a first plurality of outlets operated by a retailer, wherein an overlap between the first plurality of consumers, the second plurality of consumers, and the third plurality of consumers varies over time;
demographically weighting the loyalty card data to represent a national market;
estimating a first household spend by the third plurality of consumers for a number of products on a per-product basis using a probabilistic distribution to adjust for underreporting of product purchases;
training a machine learning model with the consumer panel data to estimate a proportion of shopping trips made by a group of consumers to a second plurality of outlets not included in the first plurality of outlets; and
estimating a second household spend by the third plurality of consumers on one of the number of products on a per outlet basis by applying the machine learning model to identify unreported purchases of the one of the number of products in the loyalty card data by the third plurality of consumers.

18. The computer program product of claim 17, wherein the probabilistic distribution includes a beta binomial/negative binomial hurdle distribution.

19. The computer program product of claim 17, wherein the machine learning model uses one or more predictors based on one or more items included in each of the consumer panel data and the loyalty card data, the one or more predictors including at least one of an income, a family composition, a geographic category, and a distance from retailers.

20. A system, comprising:
one or more data sources including point of sale data for a first plurality of consumers, consumer panel data for a second plurality of consumers, and loyalty card data for a third plurality of consumers, the loyalty card data including loyalty card purchases of one or more products by the third plurality of consumers at a first plurality of outlets operated by a retailer, wherein an overlap between the first plurality of consumers, the second plurality of consumers, and the third plurality of consumers varies over time; and
a processor and a memory, the memory storing computer code executable by the processor to:
access the point of sale data, the consumer panel data, and the loyalty card data;
demographically weight the loyalty card data to represent a national market by weighting each of a number of purchasing segments as a ratio of national households in that purchasing segment to loyalty card households in that purchasing segment;
estimate a first household spend by the third plurality of consumers for a number of products on a per-product basis using a probabilistic distribution to adjust for underreporting of product purchases within the loyalty card purchases by the third plurality of consumers based on distributions of the loyalty card data, the consumer panel data, and the point of sale data;
train a machine learning model with the consumer panel data to estimate a proportion of shopping trips made by a group of consumers to a second plurality of outlets not included in the first plurality of outlets; and
estimate a second household spend by the third plurality of consumers on one of the number of products on a per outlet basis by applying the machine learning model to identify unreported purchases of the product in the loyalty card data by the third plurality of consumers.
